(19) United States
(12) Patent Application Publication
(10) Pub. No.: US 2023/0078493 A1
(43) Pub. Date: Mar. 16, 2023

(54) SPREAD COMPOSITION

(71) Applicant: Cargill, Incorporated, Wayzata, MN (US)

(72) Inventors: Fernanda DAVOLI ZACCARELLI, Golden Valley, MN (US); Tristan LIPKIE, Maple Grove, MN (US); Gustav Maximilian WASCHATKO, Etterbeek (BE)

(73) Assignee: Cargill, Incorporated, Wayzata, MN (US)

(21) Appl. No.: 17/760,133

(22) PCT Filed: Feb. 9, 2021
(86) PCT No.: PCT/US2021/017175

§ 371 Date: Aug. 4, 2022

Related U.S. Application Data
(60) Provisional application No. 62/976,089, filed on Feb. 13, 2020.

(51) Int. Cl. A23D 7/005; A23D 7/02; A23D 7/00

(52) U.S. Cl. CPC A23D 7/0056; A23D 7/02; A23D 7/001

(57) ABSTRACT

Various aspects relate to a spread composition, methods of making the same, and food products including the same. A spread composition includes an oil phase. The oil phase includes a plant-based oil. The spread composition also includes plant-based oil bodies emulsified in the oil phase. The plant-based oil bodies are derived from the same one or more plants as the plant-based oil, a different one or more plants, or a combination thereof. The spread composition includes a continuous phase that includes the oil phase. At least some of the plant-based oil in the oil phase is not naturally present in the plant-based oil bodies.

### CROSS-REFERENCE TO RELATED APPLICATION

This application claims the benefit of priority to U.S. Provisional Patent Application Ser. No. 62/976,089 filed Feb. 13, 2020, the disclosure of which is incorporated herein in its entirety by reference.

### BACKGROUND

Spreads such as margarine are emulsions of a water phase and an oil phase from vegetable and/or animal sources. The continuous phase of the spread includes the oil phase. Emulsification of the water and oil phases to form the spread generally requires addition of an emulsifier.

### SUMMARY OF THE INVENTION

Various aspects of the present disclosure provide a spread composition. The spread composition includes an oil phase. The oil phase includes a plant-based oil. The spread composition also includes plant-based oil bodies emulsified in the oil phase. The plant-based oil bodies are derived from the same one or more plants as the plant-based oil, a different one or more plants, or a combination thereof. The spread composition includes a continuous phase that includes the oil phase. At least some of the plant-based oil in the oil phase is not naturally present in the plant-based oil bodies

Various aspects of the present disclosure provide a food product including the spread composition of the present disclosure.

Various aspects of the present disclosure provide a spread composition that is a margarine. The margarine includes an oil phase including a plant-based oil. The oil phase is 50 wt % to 95% of the margarine. The margarine includes plant-based oil bodies emulsified in the oil phase. The plant-based oil bodies are derived from the same one or more plants as the plant-based oil, a different one or more plants, or a combination thereof. The plant-based oil bodies are 5 wt % to 50 wt % of the margarine. The margarine has a total water content of 5 wt % to 40 wt % of the margarine. The margarine includes a continuous phase that includes the oil phase. The margarine is free of added emulsifiers other than those naturally present from the plant-based oil bodies. At least some of the plant-based oil in the oil phase is not naturally present in the plant-based oil bodies.

Various aspects of the present disclosure provide a method of making the spread composition of the present disclosure. The method includes melting an oil composition including a plant-based oil. The method includes emulsifying plant-based oil bodies and the melted oil composition together, to form the spread composition.

Various aspects of the present disclosure provide a method of making the spread composition of the present disclosure. The method includes pretreating the oil bodies prior to the emulsifying of the oil bodies and the melted oil composition together. The pretreating includes heating the oil bodies to an elevated temperature and shearing the heated oil bodies at the elevated temperature, or freezing the oil bodies and thawing the frozen oil bodies, or adjusting pH of the oil bodies to 3 to 6, or a combination thereof. The pretreating also includes melting an oil composition including a plant-based oil at a temperature of 40° C. to 70° C. The method includes emulsifying the oil bodies and the melted oil composition together. The method also includes crystallizing the emulsion of the oil bodies and the oil composition at 5° C. to 25° C., to form the spread composition.

Various aspects of the spread composition of the present disclosure have advantages over other spread compositions. The emulsion of the spread composition of the present disclosure can be stabilized by the emulsifiers naturally in the oil body, such as proteins and phospholipids, as was as the fat crystal of the fat phase after crystallization. The spread composition of the present disclosure can include less added emulsifier or no added emulsifier other than emulsifier naturally present from the plant-based oil bodies, advantageously providing a spread composition that has less added emulsifier and more natural content than other spread compositions. The spread composition of the present disclosure can be entirely plant-derived, having no non-plant derived materials added, providing an entirely natural spread composition. The spread composition of the present disclosure can have enhanced spreadability compared to other spread compositions. The method of making the spread composition of the present disclosure can provide energy savings over other methods of making spread composition, such as energy savings during the crystallization step. The energy savings can be greater for spread compositions of the present disclosure having higher amounts of water. The spread composition of the present disclosure can have higher protein content, such as a higher natural protein content or a higher total protein content, as compared to other spreads. The spread composition of the present disclosure can replace or be combined with spread compositions including fava beans, fava bean protein, fava bean preparations, or isolates thereof.

### BRIEF DESCRIPTION OF THE FIGURES

The drawings illustrate generally, by way of example, but not by way of limitation, various aspects of the present disclosure.

FIGS. 1a-d illustrate photographs of emulsions prepared by a heat and shear method, with the inset illustrating a magnified area of the emulsion, in accordance with various aspects.

FIGS. 2a-d illustrate photographs of emulsions prepared by a freeze and thaw method, with the inset illustrating a magnified area of the emulsion, in accordance with various aspects.

FIGS. 3a-d illustrate photographs of emulsions prepared by a method including adjusting the pH of the oil bodies, with the inset illustrating a magnified area of the emulsion, in accordance with various aspects.

FIG. 4 illustrates a photograph of an emulsion prepared by a method including heating the oil bodies and then adjusting the pH of the oil bodies, with the inset illustrating a magnified area of the emulsion, in accordance with various aspects.

FIGS. 5a-d illustrate photographs of emulsions prepared by a method including freezing, thawing, and adjusting the pH of the oil bodies, with the inset illustrating a magnified area of the emulsion, in accordance with various aspects.

FIGS. 6a-c illustrate photographs of emulsions prepared by a method including adjusting the pH of the oil bodies, with the inset illustrating a magnified area of the emulsion, in accordance with various aspects.

FIGS. 7a-d illustrate photographs of emulsions prepared by a method including adjusting the pH of the oil bodies, with the inset illustrating a magnified area of the emulsion, in accordance with various aspects.

FIGS. 8a-b illustrate CSLM images at various magnifications of an emulsion formed with an oil body extracted at pH 7.5 and adjusted to have a pH of 4, in accordance with various aspects.

FIGS. 9a-b illustrate CSLM images at various magnifications of an emulsion formed with an oil body extracted at pH 11 and adjusted to have a pH of 4, in accordance with various aspects.

FIGS. 10a-b illustrate CSLM images at various magnifications of an emulsion formed using citric acid to lower the pH of oil bodies to 4, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Spread Composition.

Various aspects of the present disclosure provide a spread composition. The spread composition includes an oil phase. The oil phase includes a plant-based oil. The spread composition also includes plant-based oil bodies that are emulsified in the oil phase. The plant-based oil bodies are derived from the same one or more plants as the plant-based oil, a different one or more plants, or a combination thereof. The spread composition includes a continuous phase. The continuous phase is the oil phase or includes the oil phase. The spread composition can be a homogeneous mixture of the oil phase and the plant-based oil bodies and any other optional one or more additional components of the spread composition. At least some of the plant-based oil in the oil phase is not naturally present in the plant-based oil bodies. The spread composition can be spreadable at refrigeration temperatures, such as such as at a temperature of 1-10° C. A component is naturally present in the plant-based oil bodies if it is part of the oil bodies at the time of their mixing with the oil composition to form the spread composition (e.g., as part of the oil bodies, as water used to extract the oil bodies, or a combination thereof). A component that is derived from oil bodies but not part of the oil bodies at the time of mixing with the oil composition (e.g., oil derived from the oil bodies but not part of the oil body extract mixed with the oil composition) is not considered to be naturally present in the oil bodies in the spread composition.

The spread composition includes an oil phase. The oil phase can be any suitable proportion of the spread composition. For example, the oil phase can be 30 wt % to 98 wt % of the spread composition, 40 wt % to 95 wt %, or 30 wt % or more, or less than, equal to, or greater than 35 wt %, 40, 45, 50, 55, 60, 65, 70, 75, 80, 85, 90, 92, 94, 96 wt %, or 98 wt % or less of the spread composition.

The oil phase can include a plant-based oil, and can optionally further include an animal-based oil. The oil phase includes at least some oil naturally present from the oil bodies; for example, 0.1 wt % to 60 wt % of the spread composition can be one or more oils naturally present from the oil bodies, or 5 wt % to 30 wt %, or 0.1 wt % or more, or less than, equal to, or greater than 0.5 wt %, 1, 2, 3, 4, 5, 6, 8, 10, 12, 14, 16, 18, 20, 22, 24, 26, 28, 30, 35, 40, 45, 50, 55 wt %, or 60 wt % or less. The oil phase can include an animal-based oil. The oil phase can be substantially free of animal-based oils. The oil phase includes one or more plant-based oils added that are not naturally present in the oil bodies. The amount of plant-based oils that are not naturally present in the oil bodies and optional animal-based oil can be 30 wt % to 94.9 wt % of the spread composition, or 50 wt % to 92 wt %, or 30 wt % or more, or less than, equal to, or greater than 35 wt %, 40, 45, 50, 55, 60, 65, 70, 75, 80, 82, 84, 86, 88, 90, 91, 92, 93, 94 wt %, or 94.9 wt % or less. The weight ratio of oil naturally present in the oil bodies to added oils not naturally present in the oil bodies can be any suitable ratio, such as 1:40-1:1, or 1:20 to 1:2, or 1:1 or more, or less than, equal to, or greater than 1:2, 1:3, 1:3, 1:5, 1:6, 1:8, 1:10, 1:12, 1:14, 1:16, 1:18, 1:20, 1:25, 1:30, 1:35, or 1:40 or less. The total amount of plant-based oil and any optional animal-based oil that is present in the spread composition can be 10 wt % to 95 wt % of the spread composition, or 50 wt % to 90 wt %, or 10 wt % or more, or less than, equal to, or greater than 15 wt %, 20, 25, 30, 35, 40, 45, 50, 55, 60, 65, 70, 75, 80, 85, 90 wt %, or 95 wt % or less of the spread composition. The plant-based oil not naturally found in the oil body (e.g., not in the oil bodies at the time of their mixing with the oil composition to form the spread composition) can be any suitable plant-based oil. For example, the plant-based oil can include coconut oil, corn oil, canola oil, cottonseed oil, olive oil, palm oil, peanut oil, rapeseed oil, safflower oil, sesame oil, soybean oil, sunflower oil, hemp oil, cocoa butter, shea butter, a fraction thereof, a high oleic version thereof, a hydrogenated oil formed therefrom, an interesterified oil formed therefrom, or a combination thereof. The plant-based oil can include cocoa butter, coconut oil, corn oil, canola oil, cottonseed oil, palm oil, rapeseed oil, safflower oil, soybean oil, sunflower oil, hemp oil, a fraction thereof, a hydrogenated oil formed therefrom, an interesterified oil formed therefrom, or a combination thereof. The plant-based oil can include palm oil. The plant-based oil can include coconut oil.

The spread composition also includes plant-based oil bodies that are emulsified in the oil phase. Oil bodies, or oleosomes, are lipid-containing structure found in plant cells. The oil bodies can be oil bodies from seeds, vascular plants, or a combination thereof. The plant-based oil bodies can form any suitable proportion of the spread composition, such as 0.1 wt % to 60 wt % of the spread composition, 5 wt % to 50 wt %, 10 wt % to 50 wt %, or 0.1 wt % or more, or less than, equal to, or greater than 0.5 wt %, 1, 2, 4, 6, 8, 10, 15, 20, 25, 30, 35, 40, 45, 50, 55 wt %, or 60 wt % or less. The oil bodies in the emulsified spread composition can be in any suitable form, such as intact, ruptured, inverted, or a combination thereof. Some or all of the oil bodies in the spread composition can be intact. Some of all of the oil bodies in the spread composition can be ruptured. Protein, water, and oil from the oil bodies are part of the spread composition; the total weight percent of spread composition that is the oil bodies is equal to the total weight percent of the spread composition that is the materials naturally present in the oil bodies, such as protein, water, oil, and any other one or more materials naturally present, whether those materials are distributed throughout the spread composition due to bursting or rupture of oil bodies, discretely confined to an intact oil body in the composition, or a combination thereof.

The plant-based oil bodies in the spread composition can include any suitable one or more plant-based oil bodies. The source of the plant-based oil bodies can be any suitable plant, such as any plant including cells that include oleosomes. The source of the cells can be a plant seed, or another plant part. The oil bodies can include oil bodies from rapeseed (Brassica spp.), soybean (Glycine max), sunflower (Helianthus annuits), oil palm (Elaeis guineeis), cottonseed (Gossypium spp.), groundnut (Arachis hypogaea), coconut (Cocus nucifera), castor (Ricinus communis), safflower (Carthamus tinctorius), mustard (Brassica spp. and Sinapis alba), coriander (Coriandrum sativum), squash (Cucurbita maxima), linseed/flax (Linum usitatissimum), Brazil nut, (Bertholletia excelsa), hazelnut (Corylus avellana), walnut (Juglands major), jojoba (Simmondsia chinensis), thale cress (Arabidopsis thaliana), wheat and wheat germ (Triticum spp.), maize and maize germ (Zea mays), amaranth (family of Amaranthus), sesame (Sesamum indicum), oat (Avena sativa), Camelina (Camelina sativa), lupin (Lupinus), peanut (Arachis hypogaea), quinoa (Chenopodium quinoa), chia (Salvia hispanica), yucca, almond (Prunus dulcis), cashew (Anacardium occidentale), olive (Olea), avocado (Persea americana), hemp (Cannabis sativa), shea (Butyrospermum parkii), cocoa bean (Theobroma cacao), argan (Argania spinosa), rice, or a combination thereof. For example, the oil bodies can include oil bodies from sunflowers, soybeans, rapeseeds, cotton seeds, canola, palm, almond, flax, corn, hemp, or a combination thereof. The oil bodies can be sunflower oil bodies.

The oil bodies can be extracted from their natural source at any suitable pH, such as at a pH of 6 to 12, or 7 to 8, or 9.5 to 10.5, or 10.5 to 11.5, or 6 or more, or less than, equal to, or greater than 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8, or 12 or less. The plant-based oil bodies can be derived from the same one or more plants as the plant-based oil, a different one or more plants, or a combination thereof. For example, the oil bodies can be sunflower oil bodies, and the plant-based oil can include palm oil, coconut oil, or a combination thereof.

Protein can form any suitable proportion of the oil bodies used to form the spread composition, such as protein that is naturally present in the oil bodies that is present before the oil bodies are combined into the spread. For example, protein naturally present in the oil bodies can be 0.1 wt % to 40 wt % of the oil bodies, 0.1 wt % to 20 wt %, or 1 wt % to 10 wt %, or 0.1 wt % or more, or less than, equal to, or greater than 0.5 wt %, 1, 2, 3, 4, 5, 6, 7, 8, 9, 10, 11, 12, 13, 14, 15, 16, 17, 18, 19, 20, 22, 24, 26, 28, 30, 32, 34, 36, 38 wt %, or 40 wt % or less of the oil bodies.

Oil (e.g., plant-based oil) can form any suitable proportion of the oil bodies used to form the spread composition, such as oil that is naturally present in the oil bodies that is present before the oil bodies are combined into the spread. For example, oil naturally present in the oil bodies can be 20 wt % to 80 wt % of the oil bodies, or 40 wt % to 60 wt %, or 20 wt % or more, or less than, equal to, or greater than 25 wt %, 30, 35, 40, 45, 50, 55, 60, 65, 70, 75 wt %, or 80 wt % or less of the oil bodies.

Water can form any suitable proportion of the oil bodies used to form the spread composition, such as water that is naturally present in the oil bodies that is present before the oil bodies are combined into the spread. For example, water naturally present in the oil bodies can be 20 wt % to 80 wt % of the oil bodies, 35 wt % to 60 wt %, 20 wt % or more, or less than, equal to, or greater than 25 wt %, 30, 35, 40, 45, 50, 55, 60, 65, 70, 75 wt %, or 80 wt % or less of the oil bodies.

The spread composition can be substantially free of added emulsifier other than those naturally present from the plant-based oil bodies. A spread composition that is free of added emulsifiers can be appealing to consumers as a more natural or nature-based product than other spread compositions that include added emulsifiers. The spread composition can include one or more added emulsifiers in addition to those naturally present from the plant-based oil bodies. The one or more added emulsifiers can be any suitable emulsifiers, such as including soy lecithin, sunflower lecithin, rapeseed lecithin, canola lecithin, palm lecithin, a distilled monoglyceride, a mono-diglyceride, polyglycerol polyricinoleate, a polyglycerol ester, propylene glycol ester, sorbitan monostearate, a citric acid ester of a mono-diglyceride, a lactic acid ester of a mono-diglyceride, an acetic acid ester of a mono-diglyceride, a sucrose ester of a fatty acid, or combinations thereof.

The spread composition can be substantially free of added protein other than that naturally present from the plant-based oil bodies. The protein in the spread composition naturally present from the oil bodies can be any suitable proportion of the spread composition, such as 0.1 wt % to 10 wt % of the spread composition, or 1 wt % to 5 wt %, or 0.1 wt % or more, or less than, equal to, or greater than 0.5 wt %, 1 wt %, 2, 3, 4, 5, 6, 7, 8, 9 wt %, or 10 wt % or less of the spread composition. The spread composition can include added protein in addition to that naturally present from the plant-based oil bodies. For example, the spread composition can include one or more added proteins in addition to that naturally present from the plant-based oil bodies that are 0.1 wt % to 10 wt % of the spread composition, or 1 wt % to 5 wt % of the spread composition, 0.1 wt % or more, or less than, equal to, or greater than 0.5 wt %, 1, 2, 3, 4, 5, 6, 7, 8, 9 wt %, or 10 wt % or less of the spread composition. The added protein can be any one or more suitable proteins, such as including vegetable protein, soy protein, canola protein, sunflower protein, rapeseed protein, corn protein, pea protein, almond protein, pumpkin protein, chia protein, coconut protein, pomegranate protein, cranberry protein, flax protein, sunflower protein, brazilnut protein, wheatgerm protein, yeast protein, algae protein, fava bean protein, isolated or concentrated versions thereof, or combinations thereof. The total amount of protein in the spread composition, including any added protein as well as protein naturally present in the oil bodies, can be any suitable proportion of the spread composition, such as 0.1 wt % to 20 wt % of the spread composition, 1 wt % to 10 wt % of the spread composition, or 0.1 wt % or more, or less than, equal to, or greater than 0.5 wt %, 1 wt %, 2, 3, 4, 5, 6, 7, 8, 9, 10, 11, 12, 13, 14, 15, 16, 17, 18, 19 wt %, or 20 wt % or less.

The spread composition is an emulsion that includes a water phase emulsified in the oil phase. The water phase can include water naturally present from the plant-based oil bodies (e.g., from within the oil bodies, from the water used to extract the oil bodies, or a combination thereof), water added to the spread composition not naturally present in the plant-based oil bodies, or a combination thereof. The spread composition can be substantially free of added water other than that naturally present from the plant-based oil bodies. The water in the spread composition naturally present from the oil bodies can be any suitable proportion of the spread composition, such as 0.1 wt % to 40 wt % of the spread composition, 0.1 wt % to 20 wt %, 0.1 wt % or more, or less than, equal to, or greater than 0.5 wt %, 1, 2, 4, 6, 8, 10, 12, 14, 16, 18, 20, 22, 24, 26, 28, 30, 32, 34, 36, 38 wt %, or 40 wt % or less of the spread composition. The spread composition can include added water in addition to that naturally present from the plant-based oil bodies. For example, the spread composition can include added water in addition to that naturally present from the plant-based oil bodies that is 0.1 wt % to 40 wt % of the spread composition, or 0.1 wt % to 20 wt %, 0.1 wt % or more, or less than, equal to, or greater than 0.5 wt %, 1, 2, 4, 6, 8, 10, 12, 14, 16, 18, 20, 22, 24, 26, 28, 30, 32, 34, 36, 38 wt %, or 40 wt % or less of the spread composition. The total amount of water in the spread composition can be any suitable amount, such as 0.1 wt % to 60 wt % of the spread composition, or 5 wt % to 40 wt %, or 0.1 wt % or more, or less than, equal to, or greater than 0.5 wt %, 1, 2, 4, 6, 8, 10, 12, 14, 16, 18, 20, 22, 24, 26, 28, 30, 32, 34, 36, 38, 40, 42, 44, 46, 48, 50, 52, 54, 56, 58 wt %, or 60 wt % or less of the spread composition. The water in the spread composition can have any suitable pH, such as a pH of 2.5 to 6, or 3.5 to 4.5, or 2.5 or more, or less than, equal to, or greater than 2.6, 2.8, 3.0, 3.2, 3.4, 3.6, 3.8, 4.0, 4.2, 4.4, 4.6, 4.8, 5.0, 5.2, 5.4, 5.6, 5.8, or 6.0 or less.

The spread composition can include or be substantially free of one or more added flavorings, vitamins, colorings, antioxidants, preservatives, or a combination thereof. The spread composition can include sodium chloride.

The spread composition can be a stable emulsion at refrigeration temperatures, such as at a temperature of 1-10° C. For example, the spread composition can be a stable emulsion, with little to no phase separation, at refrigeration temperatures for any suitable length of time, such as 1 month or more, or less than, equal to, or greater than 2 months, 3, 4, 5, 6, 7, 8, 9, 10, 11 months, 1 year, 1.5, 2, 2.5, 3, 4 years, or 5 years or less.

The spread composition is an emulsion that includes a continuous phase that includes the oil phase. A water phase is emulsified in the oil phase. The emulsion can be a water-in-oil emulsion, an oil-in-water-in-oil emulsion, or a combination thereof. The oil phase in the continuous phase can include one or more plant-based oils not naturally present in the oil bodies. None, some, or all of the oil bodies in the spread composition are inverted such that they include an oil phase in a continuous water phase. The spread composition can include a water phase having any suitable droplet size (e.g., diameter), such as a droplet size of 1 micron to 100 microns, 5 microns to 20 microns, or 1 micron or more, or less than, equal to, or greater than 2 microns, 3, 4, 5, 6, 8, 10, 12, 14, 16, 18, 20, 25, 30, 35, 40, 45, 50, 60, 70, 80, 90 microns, or 100 microns or less. The water phase can optionally include internal droplets of the oil phase of any suitable droplet size, such as a droplet size of 0.1 micron to 10 microns, or 1 micron to 5 micron, or 0.1 microns or more, or less than, equal to, or greater than 0.5 micron, 1, 1.5, 2, 2.5, 3, 3.5, 4, 4.5, 5, 6, 7, 8, 9 microns, or 10 microns or less.

The spread composition can be any suitable spread composition consistent with the compositions described herein, such as a vegan-butter, a margarine/spread free of added emulsifiers, a plant-based butter/margarine/spread, or a combination thereof.

The spread composition can be a margarine, such as a table margarine, cooking margarine, an industrial margarine (e.g., cake margarine, Danish pastry margarine, puff pastry margarine, multi-purpose margarine, frying margarine), or a combination thereof.

### Food Product Including the Spread Composition.

Various aspects of the present disclosure provide a food product that includes the spread composition of the present disclosure. The food product can be any suitable food product that is conventionally prepared with a spread or margarine, such as a dessert, a cake, a cookie, a cake frosting, a bakery product, a chocolate spread, or a combination thereof. Various aspects of the present disclosure provide a method of making the food product comprising using the spread composition of the present disclosure in the preparation of the food product (e.g., incorporating into the food product or a precursor thereto) such that the food product includes the spread composition.

### Method of Making the Spread Composition.

Various aspects of the present disclosure provide a method of making the spread composition of the present disclosure. The method can be any suitable method that forms the spread composition. The method of making the spread composition can include melting an oil composition including a plant-based oil and optionally including an animal-based oil. The method can also include emulsifying the oil bodies and the melted oil composition together, to form the spread composition of the present disclosure.

The melting of the oil composition can be performed at any suitable temperature, such as a temperature of 30° C. to 90° C., or 40° C. to 70° C., or 30° C. or less, or less than, equal to, or greater than 35° C., 40, 42, 44, 46, 48, 50, 52, 54, 56, 58, 60, 62, 64, 66, 68, 70, 75, 80, 85° C., or 90° C. or less. The combination of the oil bodies and the melted oil composition and the emulsification thereof can be performed with the oil composition at the heated oil composition temperature that is obtained during the melting of the oil composition.

The oil bodies can be at any suitable temperature relative to the temperature of the melted oil composition during the combining and mixing thereof to emulsify the oil bodies and the melted oil composition. The method can include heating the oil bodies to about the same temperature as the melted oil composition prior to combining the oil bodies and the melted oil composition. For example, the method can include heating the oil bodies to a temperature that is within 10° C. to 30° C. of a temperature of the melted oil composition prior to the emulsifying of the oil bodies and the melted oil composition.

The method can include pretreating the oil bodies prior to the emulsifying of the oil bodies and the melted oil composition together. The pretreatment can be any suitable pretreatment. The pretreatment can include heating the oil bodies to an elevated temperature and shearing the heated oil bodies at the elevated temperature; or freezing the oil bodies and thawing the frozen oil bodies; or adjusting pH of the oil bodies to 3 to 6; or a combination thereof.

The pretreatment can include heating the oil bodies to an elevated temperature and shearing the heated oil bodies at the elevated temperature. The elevated temperature can be any suitable temperature, such as 35° C. to 80° C., 40° C. to 70° C., or 35° C. or more, or less than, equal to, or greater than 40° C., 45, 50, 55, 60, 65, 70, 75° C., or 80° C. or less. The shearing can be conducted at the elevated temperature for any suitable range of time, such as 1 minute to 1 hour, 5 minutes to 30 minutes, at least 1 minute, at least 30 minutes, at least 1 hour, or 5 minutes or more, or less than, equal to, or greater than 10 minutes, 15, 20, 30, 35, 40, 45, 50, 55 minutes, or 1 hour or less.

The pretreatment can include freezing the oil bodies and thawing the frozen oil bodies. The freezing can include maintaining the oil bodies below 0° C. for any suitable time, such as 1 minute to 1 week, 12 hours to 48 hours, at least 1 minute, at least 12 hours, at least 48 hours, or 1 minute or more, or less than, equal to, or greater than 10 minutes, 20, 30, 40, 50 minutes, 1 hour, 2, 4, 6, 8, 10, 12, 14, 16, 18, 20, 24, 36 hours, or 48 hours or less.

The pretreatment can include adjusting the pH of the oil bodies to a suitable level for formation of the spread composition, such as adjusting the pH to 3 to 6, 4 to 5, or 3 or more, or less than, equal to, or greater than 3.5, 4, 4.5, 5, 5.5, or 6 or less.

The pretreatment can include heating the oil bodies to an elevated temperature and shearing the heated oil bodies at the elevated temperature. The pretreatment can also adjusting pH of the heated and sheared oil bodies to 3 to 6 (e.g., with the oil bodies at the elevated temperature).

The pretreatment can include adjusting pH of the oil bodies to 3 to 6 (e.g., 4 to 5, or 3 or more, or less than, equal to, or greater than 3.5, 4, 4.5, 5, 5.5, or 6 or less). The pretreatment can also include heating the pH-adjusted oil bodies to an elevated temperature and shearing the heated oil bodies at the elevated temperature.

The pretreatment can include freezing the oil bodies and thawing the frozen oil bodies. The pretreatment can also include adjusting pH of the frozen and thawed oil bodies to 3 to 6 (e.g., 4 to 5, or 3 or more, or less than, equal to, or greater than 3.5, 4, 4.5, 5, 5.5, or 6 or less).

The pretreatment can include adjusting pH of the oil bodies to freezing the oil bodies and thawing the frozen oil bodies. The pretreatment can also include adjusting pH of the frozen and thawed oil bodies to 3 to 6 (e.g., 4 to 5, or 3 or more, or less than, equal to, or greater than 3.5, 4, 4.5, 5, 5.5, or 6 or less).

The method of forming the spread composition can include crystallizing the emulsion of the oil bodies and the oil composition, to form the spread. The crystallizing can include lowering the temperature of the combination of the oil bodies and the oil composition to a suitable temperature, such as 0° C. to 30° C., 5° C. to 25° C., or 0° C. or more, or less than, equal to, or greater than 1° C., 2, 3, 4, 5, 6, 7, 8, 9, 10, 11, 12, 13, 14, 15, 16, 17, 18, 19, 20, 21, 22, 23, 24, 25, 26, 27, 28, 29° C., or 30° C. or less.

### EXAMPLES

Various aspects of the present disclosure can be better understood by reference to the following Examples which are offered by way of illustration. The present disclosure is not limited to the Examples given herein.

Materials. The materials used included the following: sunflower oleosomes (oil bodies) extracted at pH 7.5; sunflower oleosomes (oil bodies) extracted at pH 11; sunflower oleosomes (oil bodies) extracted at pH 10; palm oil; palm stearin; coconut oil; sunflower oil; and fully hydrogenated cotton (FHC). Table 1 illustrates the composition of the sunflower oleosomes extracted at pH 7.6 and pH 11.

TABLE 1
Composition of sunflower oleosomes
extracted at pH 7.6 and pH 11.

| | Sunflower oil bodies | Sunflower oil bodies |
|---|---|---|
| | (extraction at pH 7.5) | (extraction at pH 11) |
| Water | 50% | 41% |
| Oil | 45% | 56% |
| Protein | 5% | 2% |

Methods. The oleosomes were used at a concentration where the final product (emulsion) would have either 5% or 20% water. The water contained in the emulsion comes mostly from the oil bodies. The additional fat phase, described in Table 2 and 3, is palm oil. The additional fat phase is the main component of the continuous phase of the emulsion and stabilizes the oil bodies within the fat crystal matrix. Tables 2 and 3 show the details of the emulsion compositions made with sunflower oil bodies extracted at pH 7.5 and pH 11. The water, oil, and protein listed in the upper section of Tables 2 and 3 are from the oil body.

TABLE 2
Emulsion compositions formed with sunflower
oil bodies extracted at pH 7.5.

| Component: | wt % | Component: | wt % |
|---|---|---|---|
| oil body at 10% | 10 | oil body at 40% | 40 |
| water 50% | 5.00 | water 50% | 20.00 |
| oil 45% | 4.50 | oil 45% | 18.00 |
| protein 5% | 0.50 | protein 5% | 2.00 |
| | 10 | | 40 |
| Additional fat phase: | | Additional fat phase: | |
| palm oil | 90.00 | palm oil | 60.00 |
| Total | 100 | Total | 100 |

TABLE 3
Emulsion compositions formed with sunflower
oil bodies extracted at pH 11.

| Component: | wt % | Component: | wt % |
|---|---|---|---|
| oil body at 12.2% | 12.2 | oil body at 48.8% | 48.8 |
| water 41% | 5.00 | water 41% | 20.01 |
| oil 56% | 6.83 | oil 56% | 27.33 |
| protein 2% | 0.24 | protein 2% | 0.98 |
| | 12.08 | | 48.31 |
| Additional fat phase: | | Additional fat phase: | |
| palm oil | 87.92 | palm oil | 51.69 |
| Total | 100 | Total | 100 |

The four emulsion compositions described in Tables 2 and 3 were tested using five different emulsion preparation processes. The crystallization parameters such as emulsion temperature and final crystallization temperature were determined based on the fat phase characteristics. Throughout the Examples, the water and protein

### Example 1. Emulsion Preparation Process 1. Heat and Shear

The oil bodies were heated up to 50° C. under high shear for 15 minutes. Palm oil was melted at 55-60° C. The heated oil bodies were added to the melted fat phase under agitation. Mixing was performed vigorous for 10 minutes avoiding air incorporation. Emulsion stability was checked, using a volumetric cylinder, taking a picture 5 minutes after taking sample of emulsion. The emulsion was crystalized using an ice bath or using a pilot scraped surface heat exchanger at 10° C. The emulsion was kept refrigerated. Using this procedure, four emulsions were prepared and crystalized using the conditions shown in Table 4. The % water shown in Table 4 is the percent water in the compositions from the oil bodies and no additional water was added.

TABLE 4
Process 1 conditions.

| | | Oil | | | Crystallized |
|---|---|---|---|---|---|
| | | body | Palm oil | Emulsion | emulsion |
| | | temp | temp | temp | temp |
| Test | Oil bodies | ° C. | ° C. | ° C. | ° C. |
| 1.1 | pH 11 - 5% water | 50-55 | 56 | 46.2 | 10.1 |
| 1.2 | pH 11 - 20% water | 55-60 | 55 | 48.5 | 9.5 |
| 1.3 | pH 7.5 - 5% water | 47-60 | 60 | 46.5 | 10.6 |
| 1.4 | pH 7.5 - 20% water | 50-65 | 60 | 48.5 | 10.5 |

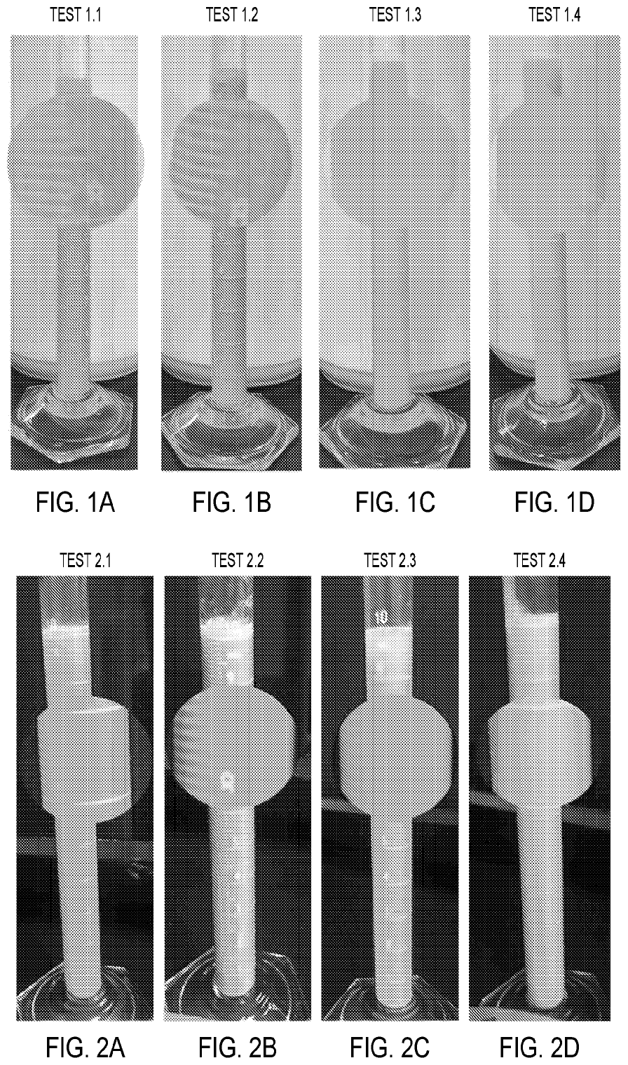

After getting a homogeneous emulsion, just before crystallization, 10 ml samples were taken and transferred to a 10 ml volumetric cylinder. The emulsions were evaluated visually for any phase separation, and a picture was taken 5 min after sampling the emulsion, prior to crystallization, as shown in FIGS. 1a-d. FIGS. 1a-d illustrate that there was no phase separation observed for any sample, suggesting the emulsions were stable.

### Example 2. Emulsion Preparation Process 2. Freeze and Thaw

The oil bodies were frozen for 24 h and refrigerated for 24 h. The frozen/thawed oil bodies were heated to 40° C. Palm oil was melted at 55-60° C. The heated oil bodies were added to the melted fat phase under agitation. Vigorous mixing was performed for 10 minutes avoiding air incorporation. Emulsion stability was checked in a volumetric cylinder. The emulsion was crystalized using an ice bath or using a pilot scraped surface heat exchanger at 10° C. The emulsion was kept refrigerated. Using this procedure, four emulsions were prepared and crystalized using the conditions shown in Table 5. The % water shown in Table 5 is the percent water in the compositions from the oil bodies and no additional water was added.

TABLE 5
Process 2 conditions.

| | | Oil | | | Crystallized |
|---|---|---|---|---|---|
| | | body | Palm oil | Emulsion | emulsion |
| | | temp | temp | temp | temp |
| Test | Oil bodies | ° C. | ° C. | ° C. | ° C. |
| 2.1 | pH 11 - 5% water | 39 | 59 | 43 | 7 |
| 2.2 | pH 11 - 20% water | 40 | 61 | 42 | 6 |
| 2.3 | pH 7.5 - 5% water | 40 | 65 | 45.5 | 9.5 |
| 2.4 | pH 7.5 - 20% water | 41 | 64 | 43 | 8 |

After getting a homogeneous emulsion, just before crystallization, 10 ml samples were taken and transferred to a 10 ml volumetric cylinder. The emulsions were evaluated visually for any phase separation, and a picture was taken 5 min after sampling the emulsion, prior to crystallization, as shown in FIGS. 2a-d. FIGS. 2a-d illustrate that there was no phase separation observed for any sample.

### Example 3. Emulsion Preparation Process 3. Adjustment of pH of Oil Bodies

The pH of the oil bodies was adjusted to 4.0-4.5. The oil bodies were heated to 40° C. Palm oil was melted at 55-60° C. The heated oil bodies were added to the melted fat phase under agitation. Vigorous mixing was performed for 10 minutes avoiding air incorporation. Emulsion stability was checked in a volumetric cylinder. The emulsion was crystalized using an ice bath or using a pilot scraped surface heat exchanger at 10° C. The emulsion was kept refrigerated. Using this procedure, four emulsions were prepared and crystalized using the conditions shown in Table 6. The % water shown in Table 6 is the percent water in the compositions from the oil bodies and no additional water was added.

TABLE 6
Process 3 conditions.

| | | Oil | | | Crystallized |
|---|---|---|---|---|---|
| | | body | Palm oil | Emulsion | emulsion |
| | | temp | temp | temp | temp |
| Test | Oil bodies | ° C. | ° C. | ° C. | ° C. |
| 3.1 | pH 11 - 5% water | 39.5 | 65 | 42.8 | 9 |
| | pH adjusted to 4.3 | | | | |
| 3.2 | pH 11 - 20% water | 36 | 58 | 36.6 | 4.4 |
| | pH adjusted to 4.0 | | | | |
| 3.3 | pH 7.5 - 5% water | 35 | 60 | 40.2 | 3.8 |
| | pH adjusted to 3.9 | | | | |
| 3.4 | pH 7.5 - 20% water | 42 | 62 | 36.1 | 2 |
| | pH adjusted to 3.9 | | | | |

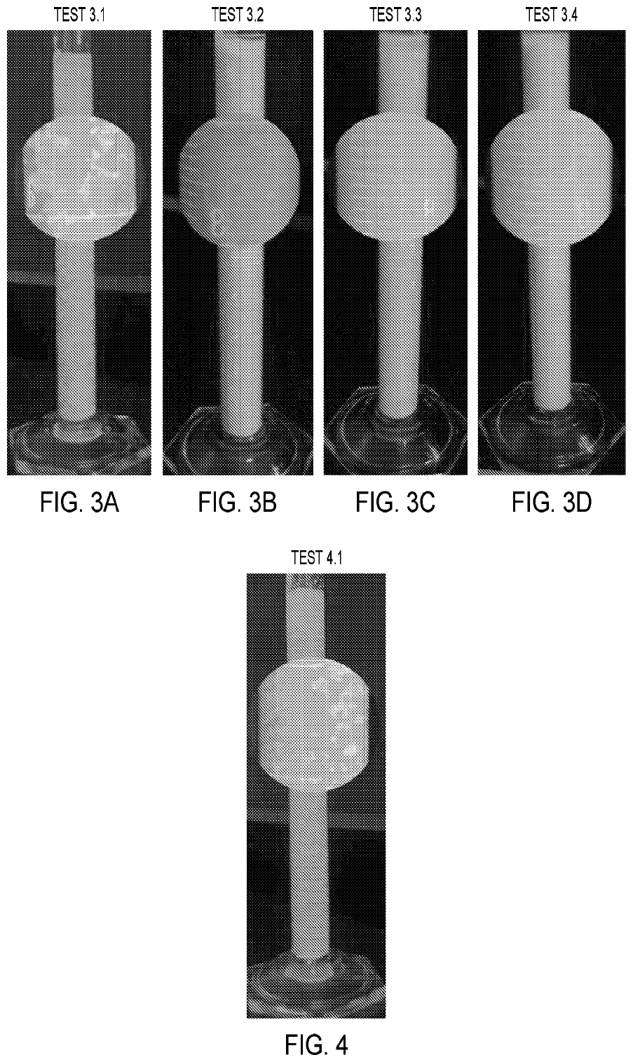

After getting a homogeneous emulsion, just before crystallization, 10 ml samples were taken and transferred to a 10 ml volumetric cylinder. The emulsions were evaluated visually for any phase separation, and a picture was taken 5 min after sampling the emulsion, prior to crystallization, as shown in FIGS. 3a-d. FIGS. 3a-d illustrate that there was no phase separation for any sample. Test 3.1 presented some phase separation thought the volumetric cylinder, nevertheless the emulsion was crystallized without problems.

### Example 4. Emulsion Preparation Process 4. Heat Oil Bodies, then Adjust pH

The oil bodies were heated to 50° C. under high shear and held for 15 minutes. The pH of the oil bodies was adjusted to 4.0-4.5. Palm oil was melted at 55-60° C. The heated oil bodies were added to the melted fat phase under agitation. Vigorous mixing was performed for 10 minutes avoiding air incorporation. Emulsion stability was checked in a volumetric cylinder. The emulsion was crystalized using an ice bath or using a pilot scraped surface heat exchanger at 10° C. The emulsion was kept refrigerated. Using this procedure, one emulsion was prepared and crystalized using the conditions shown in Table 7. The % water shown in Table 7 is the percent water in the composition from the oil bodies and no additional water was added.

TABLE 7
Process 4 conditions.

| | | Oil | | | Crystallized |
|---|---|---|---|---|---|
| | | body | Palm oil | Emulsion | emulsion |
| | | temp | temp | temp | temp |
| Test | Oil bodies | ° C. | ° C. | ° C. | ° C. |
| 4.1 | pH 11 - 5% water | 60 | 62 | 36 | 8 |
| | Heated and pH | | | | |
| | adjusted to 4.0 | | | | |

After getting a homogeneous emulsion, just before crystallization, a 10 ml sample was taken and transferred to a 10 ml volumetric cylinder. The emulsion was evaluated visually for any phase separation, and a picture was taken 5 min after sampling the emulsion, prior to crystallization, as shown in FIG. 4. FIG. 4 illustrates that there was no phase separation observed in the volumetric cylinder.

### Example 5. Emulsion Preparation Process 5. Freeze, Thaw, then Adjust pH of Oil Bodies

The oil bodies were frozen from 24 h and then refrigerated for 24 h. The frozen/thawed oil bodies were heated to 40° C. and the pH was adjusted to 4.0-4.5. Palm oil was melted at 55-60° C. The heated oil bodies were added to the melted fat phase under agitation. Vigorous mixing was performed for 10 minutes avoiding air incorporation. Emulsion stability was checked in a volumetric cylinder. The emulsion was crystalized using an ice bath or using a pilot scraped surface heat exchanger at 10° C. The emulsion was kept refrigerated. Using this procedure, one emulsion was prepared and crystalized using the conditions shown in Table 8. For tests 5.1 and 5.3 the oil bodies were frozen and thawed, and then had pH adjusted. For tests 5.2 and 5.4, the pH of the oil bodies was adjusted first, then the oil bodies were frozen and thawed. The % water shown in Table 8 is the percent water in the compositions from the oil bodies and no additional water was added.

TABLE 8
Process 5 conditions.

| | | Oil | | | Crystallized |
|---|---|---|---|---|---|
| | | body | Palm oil | Emulsion | emulsion |
| | | temp | temp | temp | temp |
| Test | Oil bodies | ° C. | ° C. | ° C. | ° C. |
| 5.1.fp | pH 11 - 5% water | 35.2 | 62.0 | 37.9 | 2.3 |
| | (freeze then pH | | | | |
| | adjusted) | | | | |
| 5.2.pf | pH 11 - 5% water | 43.8 | 49.0 | 36.7 | 7.3 |
| | (pH adjusted then | | | | |
| | frozen) | | | | |
| 5.3.fp | pH 7.5 - 5% water | 44.5 | 56.6 | 42.8 | 6.5 |
| | (freeze then pH | | | | |
| | adjusted) | | | | |
| 5.4.pf | pH 7.5 - 5% water | 41.4 | 55.5 | 43.7 | 6.4 |
| | (pH adjusted then | | | | |
| | frozen) | | | | |

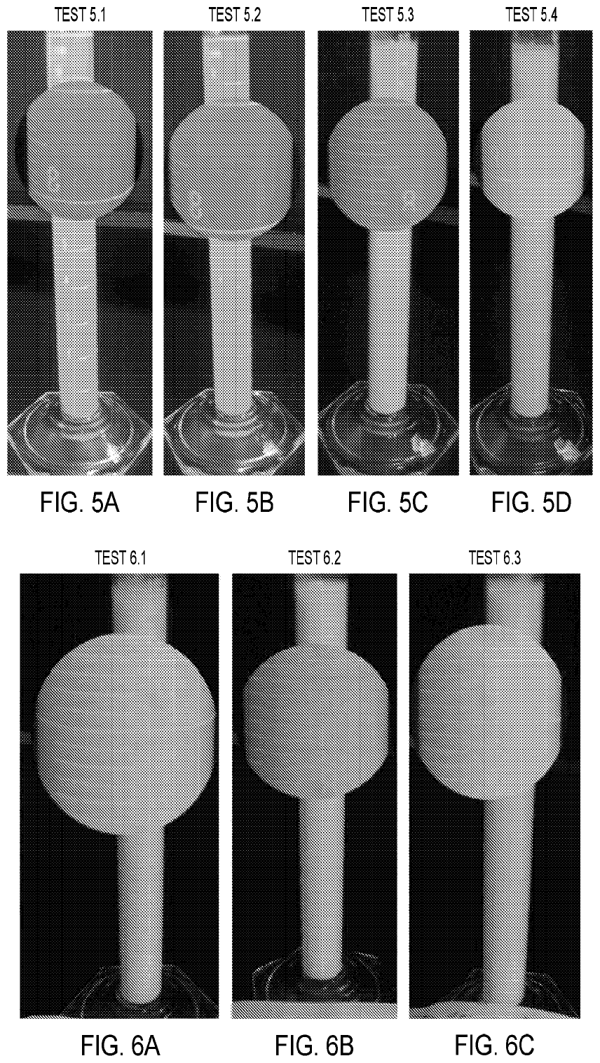

After getting a homogeneous emulsion, just before crystallization, 10 ml samples were taken and transferred to a 10 ml volumetric cylinder. The emulsions were evaluated visually for any phase separation, and a picture was taken 5 min after sampling the emulsion, prior to crystallization, as shown in FIGS. 5a-d. FIGS. 5a-d illustrate that there was no phase separation observed for any sample.

### Example 6. Fat Phase Based on Coconut Oil

The emulsion can also be prepared using different types of fat phase. In this Example, the emulsions were prepared using process 3, adjusting the pH of the oil bodies. The pH of the oil bodies was adjusted to 4.0-4.5. The oil bodies were heated to 40° C. The fat phase was melted at 55-60° C. The heated oil bodies were added to the melted fat phase under agitation. Vigorous mixing was performed for 10 minutes avoiding air incorporation. Emulsion stability was checked in a volumetric cylinder. The emulsion was crystalized using an ice bath or using a pilot scraped surface heat exchanger at 15° C. The emulsion was kept refrigerated. Using this procedure, three emulsions were prepared and crystalized using the phases shown in Table 9. Crystallization conditions for tests 1 to 3 are presented in Table 10. The emulsions were evaluated visually for any phase separation, and a picture was taken 5 min after sampling the emulsion, prior to crystallization, as shown in FIGS. 6a-c. FIGS. 6a-c illustrate that there was no phase separation observed for any sample. The % water and protein shown in Table 9 is the percent water and protein in the compositions from the oil bodies and no additional water or protein was added.

TABLE 9
Emulsions formed using coconut oil.

| Ingredients | Test 1 | Test 2 | Test 3 |
|---|---|---|---|
| Oil body | 40% | 40% | 40% |
| (sunflower | (18% oil, | (18% oil, | (18% oil, |
| pH 7.5) | 20% water, | 20% water, | 20% water, |
| | 2% protein) | 2% protein) | 2% protein) |
| Coconut oil | 60% | 46% | 32% |
| Sunflower oil | — | 14% | 28% |

TABLE 10
Conditions for crystallization of
emulsions formed using coconut oil.

| | Oil | | | Crystallized |
|---|---|---|---|---|
| | body | Fat phase | Emulsion | emulsion |
| | temp | temp | temp | temp |
| Test | ° C. | ° C. | ° C. | ° C. |
| 6.1 | 36 | 57 | 37.4 | 16.0 |
| 6.2 | 43 | 60 | 41.4 | 16.2 |
| 6.3 | 33 | 67 | 40.8 | 14.1 |

### Example 7. Oil Body Extraction at pH 10

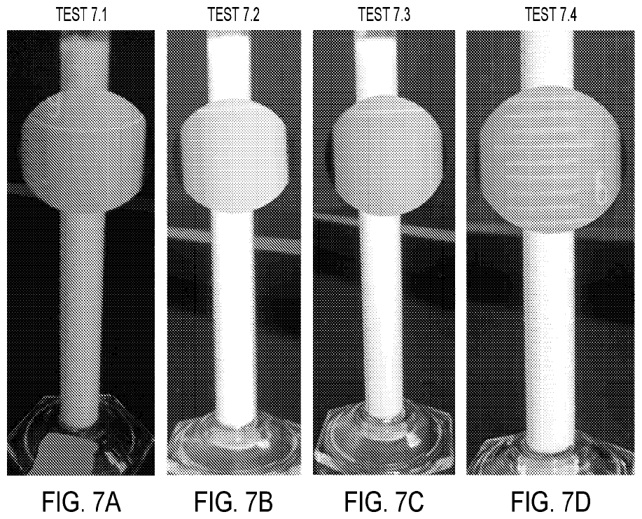

This Example show emulsions prepared using emulsion preparation process 3, adjusting the pH of the oil bodies. The oil bodies extracted at pH 10 were used, with the composition thereof described in Table 11. The pH of the oil bodies was adjusted to 4.0. The oil bodies were heated to 40° C. The fat phase was melted at 60-70° C. The heated oil bodies were added to the melted fat phase under agitation. Vigorous mixing was performed for 10 minutes avoiding air incorporation. Emulsion stability was checked in a volumetric cylinder. The emulsion was crystalized using an ice bath or using a pilot scraped surface heat exchanger at an adequate temperature. The emulsion was kept refrigerated. Using this procedure, four emulsions were prepared and crystalized using the compositions shown in Table 12. The final product water content was 20%. Crystallization conditions for tests 1 to 4 are presented in Table 13. The emulsions were evaluated visually for any phase separation, and a picture was taken 5 min after sampling the emulsion, prior to crystallization, as shown in FIGS. 7a-a. FIGS. 7a-d illustrate that there was no phase separation observed for any sample.

TABLE 11
Composition of sunflower oil bodies extracted at pH 10.

| | |
|---|---|
| Water | 50% |
| Oil | 45% |
| Protein | 5% |
| Extraction pH | 10 |
| Final pH (after extraction) | 5.3 |

TABLE 12
Emulsion composition for tests 1-4.

| Ingredients (%) | Test 7.1 | Test 7.2 | Test 7.3 | Test 7.4 |
|---|---|---|---|---|
| Oil Body | 40 | 40 | 40 | 40 |
| (pH 10 extraction) | | | | |

Fat phase

| | | | | |
|---|---|---|---|---|
| Coconut oil | — | 46 | 39.1 | 27.2 |
| Additional sunflower oil | — | 14 | 14 | 28 |
| FHC (fully hydro cotton) | — | — | 6.9 | 4.8 |
| Palm oil | 60 | — | — | — |
| Total | 100 | 100 | 100 | 100 |

TABLE 13
Crystallization conditions for tests 1-4.

| | Oil | | | Crystallized |
|---|---|---|---|---|
| | body | Fat phase | Emulsion | emulsion |
| | temp | temp | temp | temp |
| Test | ° C. | ° C. | ° C. | ° C. |
| 7.1 | 43.2 | 64.7 | 42.7 | 4.8 |
| 7.2 | 44.8 | 42.1 | 35.3 | 18.2 |
| 7.3 | 44.3 | 66.4 | 44.1 | 16.2 |
| 7.4 | 42.2 | 68.9 | 44.8 | 12.1 |

### Example 8. Industrial Margarine—Danish Pastry Margarine

An industrial margarine was also prepared, which was a Danish pastry margarine. The emulsion was prepared using emulsion preparation process 3, adjusting the pH of the oil bodies, using citric acid to lower the pH of the oil bodies to 4. The final crystallization temperature was adjusted accordingly and the final product water content was 20%. Some water was added to bring the total percent water to 20%. Table 14 shows the detailed composition of the Danish pastry margarine.

TABLE 14
Composition of Danish pastry margarine.

| | |
|---|---|
| Ingredient | % |

Water phase

| | |
|---|---|
| Water | 3.12 |
| Sunflower Oil Bodies extracted at pH 7.5 | 32.30 |

Fat Phase

| | |
|---|---|
| Palm oil | 27.45 |
| Palm stearin sunflower oil (or rapeseed oil) | 27.45 |
| Sunflower oil (or rapeseed oil) | 9.68 |
| Total | 100 |

### Example 9. Analysis of Various Results

All of Examples 1-8 produced emulsions having their fat phase as the continuous phase. The water phase coming from the oil bodies was stabilized within the fat crystal matrix. The proteins and phospholipids naturally contained in the oil bodies were responsible for the emulsion stabilization illustrating that a stable emulsion can be produced without the addition of emulsifiers (synthesized additives).

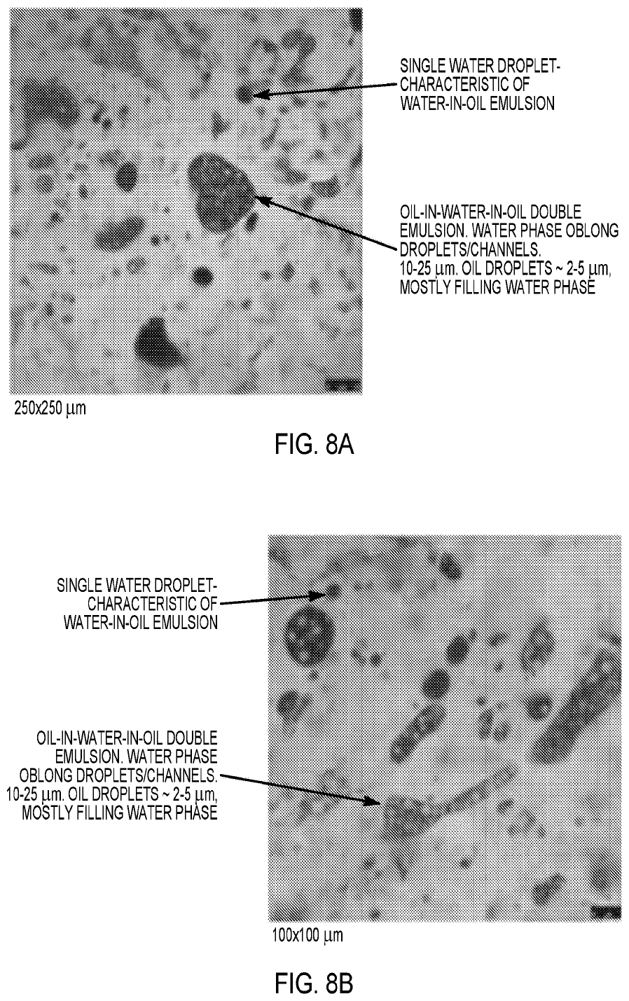

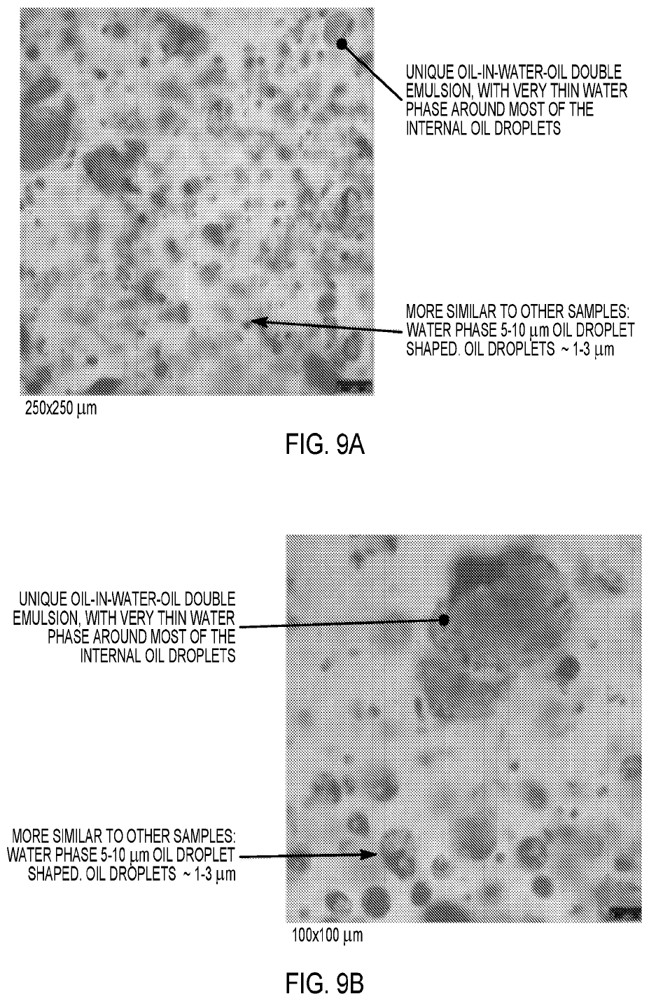

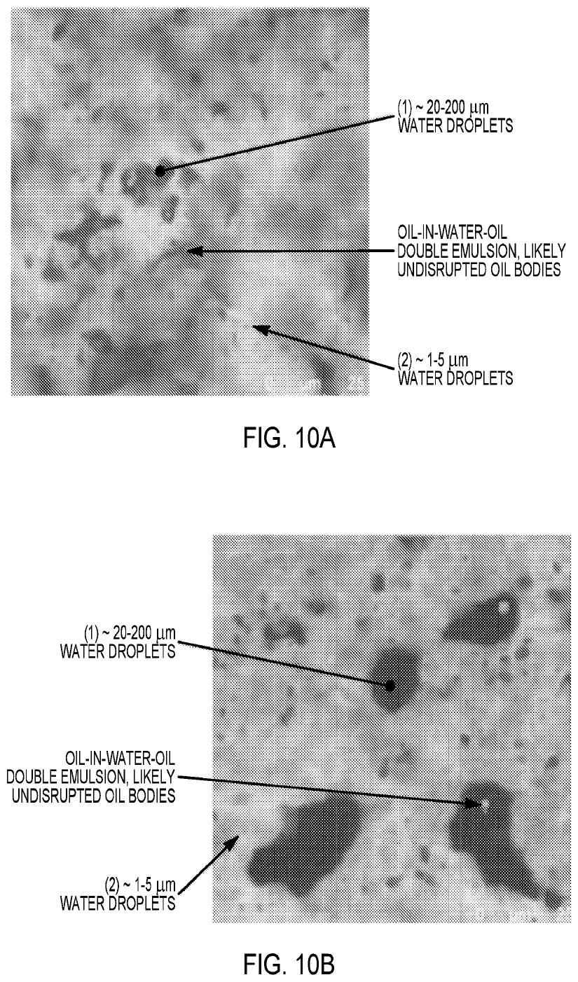

Images of various emulsion products were taken using confocal scanning laser microscopy (CSLM), wherein all phases of the emulsions (fat phase and water phase) were identified. FIGS. 8a-b illustrate CSLM images of sample 3.4 from Example 3 after crystallization, formed with an oil body extracted at pH 7.5 and adjusted to have a pH of 4 (formed via process 3), having 20% water. FIGS. 9a-b illustrate CSLM images of sample 3.2 from Example 3 after crystallization, formed with an oil body extracted at pH 11 and adjusted to have a pH of 4 (formed via process 3), having 20% water. FIGS. 10a-b illustrate CSLM images of the sample formed in Example 8 (formed via process 3) after crystallization, which used citric acid to lower the pH of oil bodies to 4, having 20% water. The images illustrate that single (water-in-oil) and double (oil-in-water-in-oil) emulsions were formed. The lighter areas of the CSLM images illustrate the liquid fat phase, the medium shade areas illustrate fat crystals, while black illustrates the water phase.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present disclosure. Thus, it should be understood that although the present disclosure has been specifically disclosed by specific aspects and optional features, modification and variation of the concepts herein disclosed may be resorted to by those of ordinary skill in the art, and that such modifications and variations are considered to be within the scope of aspects of the present disclosure.

### Exemplary Aspects.

The following exemplary aspects are provided, the numbering of which is not to be construed as designating levels of importance:

Aspect 1 provides a spread composition comprising:

an oil phase comprising a plant-based oil; and

plant-based oil bodies emulsified in the oil phase, wherein the plant-based oil bodies are derived from the same one or more plants as the plant-based oil, a different one or more plants, or a combination thereof;

wherein
the spread composition comprises a continuous phase that comprises the oil phase, and
at least some of the plant-based oil in the oil phase is not naturally present in the plant-based oil bodies.

Aspect 2 provides the spread composition of Aspect 1, wherein the spread composition is a homogeneous mixture of the oil phase and the plant-based oil bodies.

Aspect 3 provides the spread composition of any one of Aspects 1-2, wherein the spread composition is free of added emulsifiers other than those naturally present from the plant-based oil bodies.

Aspect 4 provides the spread composition of any one of Aspects 1-3, wherein the spread composition comprises one or more added emulsifiers in addition to those naturally present from the plant-based oil bodies.

Aspect 5 provides the spread composition of Aspect 4, wherein the one or more added emulsifiers comprises soy lecithin, sunflower lecithin, rapeseed lecithin, canola lecithin, palm lecithin, a distilled monoglyceride, a mono-diglyceride, polyglycerol polyricinoleate, a polyglycerol ester, propylene glycol ester, sorbitan monostearate, a citric acid ester of a mono-diglyceride, a lactic acid ester of a mono-diglyceride, an acetic acid ester of a mono-diglyceride, a sucrose ester of a fatty acid, or combinations thereof.

Aspect 6 provides the spread composition of any one of Aspects 1-5, wherein the spread composition is free of added protein other than that naturally present from the plant-based oil bodies.

Aspect 7 provides the spread composition of any one of Aspects 1-6, wherein protein in the composition naturally present from the plant oil bodies is 0.1 wt % to 10 wt % of the spread composition.

Aspect 8 provides the spread composition of any one of Aspects 1-7, wherein protein in the composition naturally present from the plant oil bodies is 1 wt % to 5 wt % of the spread composition.

Aspect 9 provides the spread composition of any one of Aspects 1-8, wherein the spread composition comprises added protein in addition to that naturally present from the plant-based oil bodies.

Aspect 10 provides the spread composition of Aspect 9, wherein the added protein is 0.1 wt % to 10 wt % of the spread composition.

Aspect 11 provides the spread composition of any one of Aspects 9-10, wherein the added protein is 1 wt % to 5 wt % of the spread composition.

Aspect 12 provides the spread composition of any one of Aspects 9-11, wherein the added protein comprises vegetable protein, soy protein, canola protein, sunflower protein, rapeseed protein, corn protein, pea protein, almond protein, pumpkin protein, chia protein, coconut protein, pomegranate protein, cranberry protein, flax protein, sunflower protein, brazilnut protein, wheatgerm protein, yeast protein, algae protein, fava bean protein, isolated or concentrated versions thereof, or combinations thereof.

Aspect 13 provides the spread composition of any one of Aspects 1-12, wherein the spread composition is free of added water other than that naturally present from the plant-based oil bodies.

Aspect 14 provides the spread composition of any one of Aspects 1-13, wherein water in the composition naturally present from the plant oil bodies is 0.1 wt % to 40 wt % of the spread composition.

Aspect 15 provides the spread composition of any one of Aspects 1-14, wherein water in the composition naturally present from the plant oil bodies is 0.1 wt % to 20 wt % of the spread composition.

Aspect 16 provides the spread composition of any one of Aspects 1-15, wherein the spread composition comprises added water in addition to that naturally present from the plant-based oil bodies.

Aspect 17 provides the spread composition of Aspect 16, wherein the added water is 0.1 wt % to 40 wt % of the spread composition.

Aspect 18 provides the spread composition of any one of Aspects 16-17, wherein the added water is 0.1 wt % to 20 wt % of the spread composition.

Aspect 19 provides the spread composition of any one of Aspects 1-18, wherein water is 0.1 wt % to 60 wt % of the spread composition.

Aspect 20 provides the spread composition of any one of Aspects 1-19, wherein water is 5 wt % to 40 wt % of the spread composition.

Aspect 21 provides the spread composition of any one of Aspects 1-20, wherein water in the spread composition has a pH of 2.5 to 6.

Aspect 22 provides the spread composition of any one of Aspects 1-21, wherein water in the spread composition has a pH of 3.5 to 4.5.

Aspect 23 provides the spread composition of any one of Aspects 1-22, wherein the oil phase is 30 wt % to 98 wt % of the spread composition.

Aspect 24 provides the spread composition of any one of Aspects 1-23, wherein the oil phase is 40 wt % to 95 wt % of the spread composition.

Aspect 25 provides the spread composition of any one of Aspects 1-24, wherein the oil phase further comprises an animal-based oil.

Aspect 26 provides the spread composition of any one of Aspects 1-25, wherein the oil phase comprises more plant-based oil not naturally present in the oil bodies than plant-based oil naturally present in the oil bodies.

Aspect 27 provides the spread composition of any one of Aspects 1-26, wherein the spread composition is free of animal-based oils.

Aspect 28 provides the spread composition of any one of Aspects 1-27, wherein the plant-based oil not naturally found in the oil bodies comprises coconut oil, corn oil, canola oil, cottonseed oil, olive oil, palm oil, peanut oil, rapeseed oil, safflower oil, sesame oil, soybean oil, sunflower oil, hemp oil, cocoa butter, shea butter, a fraction thereof, a high oleic version thereof, a hydrogenated oil formed therefrom, an interesterified oil formed therefrom, or a combination thereof.

Aspect 29 provides the spread composition of any one of Aspects 1-28, wherein the plant-based oil not naturally found in the oil bodies comprises cocoa butter, coconut oil, corn oil, canola oil, cottonseed oil, palm oil, rapeseed oil, safflower oil, soybean oil, sunflower oil, hemp oil, a fraction thereof, a hydrogenated oil formed therefrom, an interesterified oil formed therefrom, or a combination thereof.

Aspect 30 provides the spread composition of any one of Aspects 1-29, wherein the plant-based oil not naturally found in the oil bodies comprises palm oil.

Aspect 31 provides the spread composition of any one of Aspects 1-30, wherein the plant-based oil not naturally found in the oil bodies comprises coconut oil.

Aspect 32 provides the spread composition of any one of Aspects 1-31, wherein the plant-based oil bodies are 0.1 wt % to 60 wt % of the spread composition.

Aspect 33 provides the spread composition of any one of Aspects 1-32, wherein the plant-based oil bodies are 5 wt % to 50 wt % of the spread composition.

Aspect 34 provides the spread composition of any one of Aspects 1-33, wherein the oil bodies are oil bodies from sunflowers, soybeans, rapeseeds, cotton seeds, canola, palm, almond, flax, corn, hemp, or a combination thereof.

Aspect 35 provides the spread composition of any one of Aspects 1-34, wherein the oil bodies are sunflower oil bodies.

Aspect 36 provides the spread composition of any one of Aspects 1-35, wherein the oil bodies are extracted from their source at a pH of 6 to 12.

Aspect 37 provides the spread composition of any one of Aspects 1-36, wherein the oil bodies are extracted from their source at a pH of 7 to 8.

Aspect 38 provides the spread composition of any one of Aspects 1-37, wherein the oil bodies are extracted from their source at a pH of 9.5 to 10.5.

Aspect 39 provides the spread composition of any one of Aspects 1-38, wherein the oil bodies are extracted from their source at a pH of 10.5 to 11.5.

Aspect 40 provides the spread composition of any one of Aspects 1-39, wherein protein is naturally 0.1 wt % to 40 wt % of the oil bodies.

Aspect 41 provides the spread composition of any one of Aspects 1-40, wherein protein is naturally 1 wt % to 10 wt % of the oil bodies.

Aspect 42 provides the spread composition of any one of Aspects 1-41, wherein plant-based oil is naturally 20 wt % to 80 wt % of the oil bodies.

Aspect 43 provides the spread composition of any one of Aspects 1-42, wherein plant-based oil is naturally about 40 wt % to 60 wt % of the oil bodies.

Aspect 44 provides the spread composition of any one of Aspects 1-43, wherein water is naturally 20 wt % to 80 wt % of the oil bodies.

Aspect 45 provides the spread composition of any one of Aspects 1-44, wherein water is naturally 35 wt % to 60 wt % of the oil bodies.

Aspect 46 provides the spread composition of any one of Aspects 1-45, wherein 10 wt % to 95 wt % of the spread composition is the plant-based oil and any animal-based oil present.

Aspect 47 provides the spread composition of any one of Aspects 1-46, wherein 50 wt % to 90 wt % of the spread composition is the plant-based oil and any animal-based oil present.

Aspect 48 provides the spread composition of any one of Aspects 1-47, wherein the oil bodies in the spread composition are intact, ruptured, inverted, or a combination thereof.

Aspect 49 provides the spread composition of any one of Aspects 1-48, wherein some or all of the oil bodies in the spread composition are intact.

Aspect 50 provides the spread composition of any one of Aspects 1-49, wherein some or all of the oil bodies in the spread composition are ruptured.

Aspect 51 provides the spread composition of any one of Aspects 1-50, wherein the oil phase in the continuous phase comprises one or more plant-based oils naturally present in the oil bodies.

Aspect 52 provides the spread composition of any one of Aspects 1-51, wherein some or all of the oil bodies in the spread composition are inverted such they comprise an oil phase in a continuous water phase.

Aspect 53 provides the spread composition of any one of Aspects 1-52, further comprising one or more added flavorings, vitamins, colorings, antioxidants, preservatives, or a combination thereof.

Aspect 54 provides the spread composition of any one of Aspects 1-53, further comprising sodium chloride.

Aspect 55 provides the spread composition of any one of Aspects 1-54, wherein the spread composition is a stable emulsion at refrigeration temperatures.

Aspect 56 provides the spread composition of any one of Aspects 1-55, wherein the spread composition is a stable emulsion at a temperature of 1-10° C.

Aspect 57 provides the spread composition of any one of Aspects 1-56, wherein the spread composition is a stable emulsion at 1-10° C. for one month or more.

Aspect 58 provides the spread composition of any one of Aspects 1-57, wherein the emulsion is a water-in-oil emulsion, an oil-in-water-in-oil emulsion, or a combination thereof.

Aspect 59 provides the spread composition of any one of Aspects 1-58, wherein the spread composition comprises a water phase having a droplet size of 1 micron to 100 microns.

Aspect 60 provides the spread composition of any one of Aspects 1-59, wherein the spread composition comprises a water phase having a droplet size of 5 microns to 20 microns.

Aspect 61 provides the spread composition of any one of Aspects 59-60, wherein the water phase comprises internal droplets of the oil phase, the oil phase droplets having a droplet size of 0.1 micron to 10 microns.

Aspect 62 provides the spread composition of any one of Aspects 59-62, wherein the water phase comprises internal droplets of the oil phase, the oil phase droplets having a droplet size of 1 micron to 5 microns.

Aspect 63 provides the spread composition of any one of Aspects 1-62, wherein the spread composition is spreadable at refrigeration temperatures.

Aspect 64 provides the spread composition of any one of Aspects 1-63, wherein the spread composition is a vegan-butter, a margarine/spread free of added emulsifiers, a plant-based butter/margarine/spread, or a combination thereof.

Aspect 65 provides the spread composition of any one of Aspects 1-64, wherein the spread composition is a margarine.

Aspect 66 provides the spread composition of Aspect 65, wherein the margarine is a table margarine, cooking margarine, an industrial margarine, or a combination thereof.

Aspect 67 provides a spread composition that is a margarine comprising:

an oil phase comprising a plant-based oil, wherein the oil phase is 50 wt % to 95% of the margarine;

plant-based oil bodies emulsified in the oil phase, wherein the plant-based oil bodies are 5 wt % to 50 wt % of the margarine, wherein the plant-based oil bodies are derived from the same one or more plants as the plant-based oil, a different one or more plants, or a combination thereof; and

a total water content of 5 wt % to 40 wt % of the margarine;

wherein
the margarine comprises a continuous phase that comprises the oil phase,
the margarine is free of added emulsifiers other than those naturally present from the plant-based oil bodies, and
at least some of the plant-based oil in the oil phase is not naturally present in the plant-based oil bodies.

Aspect 68 provides a food product comprising the spread composition of any one of Aspects 1-67.

Aspect 69 provides the food product of Aspect 68 wherein the food product comprises a dessert, a cake, a cookie, a cake frosting, a bakery product, a chocolate spread, or a combination thereof.

Aspect 70 provides a method of making the spread composition of any one of Aspects 1-67, the method comprising

melting an oil composition comprising a plant-based oil; and

emulsifying the oil bodies and the melted oil composition together, to form the spread composition.

Aspect 71 provides the method of Aspect 70, wherein melting the oil composition comprises heating the oil composition to a temperature of 30° C. to 90° C.

Aspect 72 provides the method of any one of Aspects 70-71, wherein melting the oil composition comprises heating the oil composition to a temperature of 40° C. to 70° C.

Aspect 73 provides the method of any one of Aspects 70-72, wherein the oil bodies are at about the same temperature as the melted oil composition during the emulsifying of the oil bodies and the melted oil composition.

Aspect 74 provides the method of Aspect 73, comprising heating the oil bodies to about the same temperature as the melted oil composition prior to the emulsifying of the oil bodies and the melted oil composition.

Aspect 75 provides the method of any one of Aspects 73-74, comprising heating the oil bodies to a temperature that is within 10° C. to 30° C. of a temperature of the melted oil composition prior to the emulsifying of the oil bodies and the melted oil composition.

Aspect 76 provides the method of any one of Aspects 70-75, further comprising pretreating the oil bodies prior to the emulsifying of the oil bodies and the melted oil composition together.

Aspect 77 provides the method of Aspect 76, wherein the pretreatment comprises:

heating the oil bodies to an elevated temperature and shearing the heated oil bodies at the elevated temperature; or

freezing the oil bodies and thawing the frozen oil bodies; or

adjusting pH of the oil bodies to 3 to 6; or

a combination thereof.

Aspect 78 provides the method of any one of Aspects 76-77, wherein the pretreatment comprises heating the oil bodies to an elevated temperature and shearing the heated oil bodies at the elevated temperature.

Aspect 79 provides the method of Aspect 78, wherein the elevated temperature is 35° C. to 80° C.

Aspect 80 provides the method of any one of Aspects 78-79, wherein the elevated temperature is 40° C. to 70° C.

Aspect 81 provides the method of any one of Aspects 78-80, comprising shearing the heated oil bodies at the elevated temperature for 1 minute to 1 hour.

Aspect 82 provides the method of any one of Aspects 78-81, comprising shearing the heated oil bodies at the elevated temperature for 5 minutes to 30 minutes.

Aspect 83 provides the method of any one of Aspects 76-82, wherein the pretreatment comprises freezing the oil bodies and thawing the frozen oil bodies.

Aspect 84 provides the method of Aspect 83, wherein the freezing comprises maintaining the oil bodies below 0° C. for 1 minute to 1 week.

Aspect 85 provides the method of any one of Aspects 83-84, wherein the freezing comprises maintaining the oil bodies below 0° C. for 12 hours to 48 hours.

Aspect 86 provides the method of any one of Aspects 76-85, wherein the pretreatment comprises adjusting pH of the oil bodies to 3 to 6.

Aspect 87 provides the method of Aspect 86, wherein the pretreatment comprises adjusting the pH of the oil bodies to 4 to 5.

Aspect 88 provides the method of any one of Aspects 76-87, wherein the pretreatment comprises:

heating the oil bodies to an elevated temperature and shearing the heated oil bodies at the elevated temperature; and

adjusting pH of the heated and sheared oil bodies to 3 to 6.

Aspect 89 provides the method of any one of Aspects 76-88, wherein the pretreatment comprises:

adjusting pH of the oil bodies to 3 to 6; and

heating the pH-adjusted oil bodies to an elevated temperature and shearing the heated oil bodies at the elevated temperature.

Aspect 90 provides the method of any one of Aspects 76-89, wherein the pretreatment comprises:

freezing the oil bodies and thawing the frozen oil bodies; and

adjusting pH of the frozen and thawed oil bodies to 3 to 6.

Aspect 91 provides the method of any one of Aspects 76-90, wherein the pretreatment comprises:

adjusting pH of the oil bodies to freezing the oil bodies and thawing the frozen oil bodies; and

adjusting pH of the frozen and thawed oil bodies to 3 to 6.

Aspect 92 provides the method of any one of Aspects 70-91, further comprising crystallizing the emulsion of the oil bodies and the oil composition, to form the spread.

Aspect 93 provides the method of Aspect 92, wherein the crystallizing comprises lowering a temperature of the emulsion of the oil bodies and the oil composition to 0° C. to 30° C.

Aspect 94 provides the method of any one of Aspects 92-93, wherein the crystallizing comprises lowering a temperature of the emulsion of the oil bodies and the oil composition to 5° C. to 25° C.

Aspect 95 provides a method of making the spread composition of any one of Aspects 1-67, the method comprising:

pretreating the oil bodies prior to the emulsifying of the oil bodies and the melted oil composition together, the pretreating comprising
heating the oil bodies to an elevated temperature and shearing the heated oil bodies at the elevated temperature, or
freezing the oil bodies and thawing the frozen oil bodies, or
adjusting pH of the oil bodies to 3 to 6, or
a combination thereof;

melting an oil composition comprising a plant-based oil at a temperature of 40° C. to 70° C.;

emulsifying the oil bodies and the melted oil composition together;

crystallizing the emulsion of the oil bodies and the oil composition at 5° C. to 25° C., to form the spread composition.

Aspect 96 provides the spread composition, food composition, or method of making the spread composition of any one or any combination of Aspects 1-95 optionally configured such that all elements or options recited are available to use or select from.

1. A spread composition comprising:
an oil phase comprising a plant-based oil; and
plant-based oil bodies emulsified in the oil phase, wherein the plant-based oil bodies are derived from the same one or more plants as the plant-based oil, a different one or more plants, or a combination thereof;
wherein
the spread composition comprises a continuous phase that comprises the oil phase, and
at least some of the plant-based oil in the oil phase is not naturally present in the plant-based oil bodies.

2. The spread composition of claim 1, wherein the spread composition is free of added emulsifiers other than those naturally present from the plant-based oil bodies.

3. The spread composition of claim 1, wherein the spread composition is free of added protein other than that naturally present from the plant-based oil bodies, free of added water other than that naturally present from the plant-based oil bodies, or a combination thereof.

4. The spread composition of claim 1, wherein water is 0.1 wt % to 60 wt % of the spread composition.

5. The spread composition of claim 1, wherein the oil phase is 30 wt % to 98 wt % of the spread composition.

6. The spread composition of claim 1, wherein the plant-based oil not naturally found in the oil bodies comprises coconut oil, corn oil, canola oil, cottonseed oil, olive oil, palm oil, peanut oil, rapeseed oil, safflower oil, sesame oil, soybean oil, sunflower oil, hemp oil, cocoa butter, shea butter, a fraction thereof, a high oleic version thereof, a hydrogenated oil formed therefrom, an interesterified oil formed therefrom, or a combination thereof.

7. The spread composition of claim 1, wherein the plant-based oil bodies are 0.1 wt % to 60 wt % of the spread composition.

8. The spread composition of claim 1, wherein the oil bodies are oil bodies from sunflowers, soybeans, rapeseeds, cotton seeds, canola, palm, almond, flax, corn, hemp, or a combination thereof.

9. The spread composition of claim 1, wherein 10 wt % to 95 wt % of the spread composition is the plant-based oil and any animal-based oil present.

10. The spread composition of claim 1, wherein the oil bodies in the spread composition are intact, ruptured, inverted, or a combination thereof.

11. The spread composition of claim 1, wherein the oil phase comprises one or more plant-based oils naturally present in the oil bodies.

12. The spread composition of claim 1, wherein the spread composition is a stable emulsion at 1-10° C. for one month or more.

13. The spread composition of claim 1, wherein the spread composition is a margarine, vegan-butter, a margarine/spread free of added emulsifiers, a plant-based butter/margarine/spread, or a combination thereof.

14. A food product comprising the spread composition of claim 1.

15. A margarine comprising:
an oil phase comprising a plant-based oil, wherein the oil phase is 50 wt % to 95% of the margarine;
plant-based oil bodies emulsified in the oil phase, wherein the plant-based oil bodies are 5 wt % to 50 wt % of the margarine, wherein the plant-based oil bodies are derived from the same one or more plants as the plant-based oil, a different one or more plants, or a combination thereof; and
a total water content of 5 wt % to 40 wt % of the margarine;
wherein
the margarine comprises a continuous phase that comprises the oil phase,
the margarine is free of added emulsifiers other than those naturally present from the plant-based oil bodies, and
at least some of the plant-based oil in the oil phase is not naturally present in the plant-based oil bodies.

16. A method of making a spread composition, the method comprising
melting an oil composition comprising a plant-based oil; and
emulsifying oil bodies and the melted oil composition together, to form a spread composition comprising
an oil phase comprising the plant-based oil, and
plant-based oil bodies emulsified in the oil phase, wherein the plant-based oil bodies are derived from the same one or more plants as the plant-based oil, a different one or more plants, or a combination thereof,
wherein the spread composition comprises a continuous phase that comprises the oil phase.

17. The method of claim 16, wherein melting the oil composition comprises heating the oil composition to a temperature of 30° C. to 90° C.

18. The method of claim 16, comprising heating the oil bodies to a temperature that is within 10° C. to 30° C. of a temperature of the melted oil composition prior to the emulsifying of the oil bodies and the melted oil composition.

19. The method of claim 16, further comprising pretreating the oil bodies prior to the emulsifying of the oil bodies and the melted oil composition together, wherein the pretreatment comprises:
heating the oil bodies to an elevated temperature and shearing the heated oil bodies at the elevated temperature; or
freezing the oil bodies and thawing the frozen oil bodies; or
adjusting pH of the oil bodies to 3 to 6; or
a combination thereof.

20. A method of making the spread composition of claim 1, the method comprising:
pretreating the oil bodies prior to the emulsifying of the oil bodies and the melted oil composition together, the pretreating comprising
heating the oil bodies to an elevated temperature and shearing the heated oil bodies at the elevated temperature, or
freezing the oil bodies and thawing the frozen oil bodies, or
adjusting pH of the oil bodies to 3 to 6, or
a combination thereof;
melting an oil composition comprising a plant-based oil at a temperature of 40° C. to 70° C.;
emulsifying the oil bodies and the melted oil composition together; and
crystallizing the emulsion of the oil bodies and the oil composition at 5° C. to 25° C., to form the spread composition.
